(19) United States
(12) Patent Application Publication
(10) Pub. No.: US 2026/0154437 A1
(43) Pub. Date: Jun. 4, 2026

(54) SYSTEM AND METHOD FOR CLIENT-SERVER MODEL INCLUDING AI-ENABLED PROCESSING FOR SECURE AND RELIABLE COMMUNICATIONS

(71) Applicant: Remnant Financial Foundation, Los Angeles, CA (US)

(72) Inventors: Chunun Kang, Irvine, CA (US); Kyung Kim, Los Angeles, CA (US); Kyoung Su Lee, Irvine, CA (US); Bonjun Koo, Chino, CA (US)

(21) Appl. No.: 19/453,484

(22) Filed: Jan. 20, 2026

Related U.S. Application Data
(63) Continuation-in-part of application No. 18/379,649, filed on Oct. 12, 2023.

(51) Int. Cl. G06F 21/62; G06F 16/248; G06F 21/64

(52) U.S. Cl. CPC G06F 21/6218; G06F 16/248; G06F 21/64

(57) ABSTRACT

A method implemented on an AI-enabled server device is provided. The method may include receiving a query of a user of the AI-enabled device. The method may include receiving a query of a user of the AI-enabled device, wherein the query comprises data and a source indicator. The method may include determining whether the source indicator matches an entry in a trusted database; upon determining the source indicator matches an entry, assigning at least one classification to the data. The method may include determining a filter mask for the data. The method may include selectively filter the data based on the mask. The method may include creating a set of data tags for the data. The method may include selectively applying the set of data tags to the data. The method may include creating a hash of the filtered data and the associated tags. The method may include storing the hash with the filtered data and the associated tags to the trusted data storage.

### BACKGROUND

### Field

The present disclosure relates to mobile, server, and artificial intelligence-enable devices and methods requiring secure and reliable communications.

### Background

Artificial intelligence (AI) systems including those applying large language models (LLMs) and knowledge graphs and knowledge bases have exploded in popularity and usage in recent times. These AI systems are trained on and able to process very large amounts of data including text, voice, imagery, etc. With advances in computation hardware and graphical processing units (GPUs) in particular, AI systems have enabled broad linguistic and world knowledge. AI systems have demonstrated versatility across various tasks.

Despite their utility, however, AI systems come with significant issues. For example, some AI output includes displays of information presented confidently with information that is false, misleading, or unfounded. When AI systems output incorrect output, it is generally considered to be a hallucination. The reason that AI systems hallucinate arises due to the statistical nature of output generation. Als including LLMs may combine fragments of training data in plausible but incorrect ways or they may infer information with plausible logic but lacking grounding in any verified source. Some types of hallucinations include: factual inaccuracies such as incorrect dates, names, or historical events; fabricated citations or sources; unwarranted conclusions such as incorrect logical reasoning or invented details.

Hallucinations are problematic because they undermine trust in AI systems and can lead to harmful decisions, especially in the fields of medicine, law, and finance where substantial health and money may be at stake. As well, AI systems have shown significant environmental impact from their incredible energy usage, both in preparation of the system (e.g., training neural networks) and running the systems or models. In addition, AI systems present a need for security and data integrity. Both the source data (e.g., training data) and the communication channels are subject to scrutiny so that security and data integrity are in need of solutions.

Accordingly, there is a need for secure and reliable communications in AI systems that address the above problems associate with usage of such systems.

### SUMMARY

In an aspect of the disclosure, a method implemented on an AI-enabled server device is provided. The method may include receiving a query of a user of the AI-enabled device, wherein the query comprises data and a source indicator. The method may include determining whether the source indicator matches an entry in a trusted database; upon determining the source indicator matches an entry, assigning at least one classification to the data. The method may include determining a filter mask for the data. The method may include selectively filter the data based on the mask. The method may include creating a set of data tags for the data. The method may include selectively applying the set of data tags to the data. The method may include creating a hash of the filtered data and the associated tags. The method may include storing the hash with the filtered data and the associated tags to the trusted data storage.

In an aspect of the disclosure, a method implemented on an AI-enabled server device is provided. The method may include receiving a query of a user of the AI-enabled device. The method may include retrieving a set of values associated with the query, prior to generating an output of the query using a knowledge base or a large-language-model (LLM). The method may include determining whether any value in the set of values is within a threshold value. The method may include, upon determining at least one value within the threshold value, (1) sending the value as an output to the user, and (2) optionally, incrementing a usage statistic associated with the value. The method may include, upon determining that no value is within a threshold value, (1) generating an output of the query using the knowledge base or the LLM, (2), calculating at least one of a hash value, a checksum, or a vector for the output, (3), storing the at least one of a hash value, a checksum, or a vector with the output as a value of the query, (4) optionally, initializing a usage statistic associated with the value, and (5) sending the output to the user.

In another aspect of the disclosure, another method implemented on an AI-enabled server device is provided. The method may include receiving a query of a user of the AI-enabled device. The method may include generating an output of the query using a knowledge base or a large-language-model (LLM). The method may include generating a cryptographic value based on the output of the query. The method may include sending the cryptographic value to the user

### BRIEF DESCRIPTION OF THE DRAWINGS

The present disclosure is illustrated by way of example, and not by way of limitation, and may be more fully understood with reference to the following detailed description when considered in connection with the figures below.

FIG. 1 illustrates an exemplary financial services processing application including mobile financial processing units, a business-to-business (B2B) financial services process unit, a mortgage processor server system, and a data storage unit, according to an embodiment of the disclosure.

FIG. 2 is an exemplary block diagram of the mobile financial services processing unit device of FIG. 1, according to an embodiment of the disclosure.

FIG. 3 is an exemplary AI-enabled system that may be the mobile financial processing unit, or the B2B financial processing server unit, or the mortgage processer server system, or a separate system coupled to any one of the units described herein, according to an embodiment of the disclosure.

FIG. 4 is a diagram illustrating the process flow for training an AI model using a dataset with a deep neural network including a set of parameters, according to an embodiment of the disclosure.

FIG. 5 is an exemplary diagram illustrating a display screen of a mobile device showing a dashboard view of available functions, according to an embodiment of the disclosure.

FIG. 6 is an exemplary diagram illustrating a display screen of a mobile device showing prompts and responses, according to an embodiment of the disclosure.

FIG. 7 is an exemplary diagram illustrating a display screen of a mobile device showing question and answer panels, according to an embodiment of the disclosure.

FIG. 8 is an exemplary flow diagram illustrating a method of monitoring a user status or condition, according to an embodiment of the disclosure.

FIG. 9 is an exemplary flow diagram illustrating a method of determining available products, according to an embodiment of the disclosure.

FIG. 10 is an exemplary flow diagram illustrating a method of the provision of financial services, according to an embodiment of the disclosure.

FIG. 11 is an exemplary flow diagram illustrating a method of detecting a trigger for a changed condition of the user.

FIG. 12 is an exemplary block diagram of a system including a trusted-data source supplying data to an AI engine interfacing to a user application.

FIG. 13 is another exemplary block diagram of a system including a trusted-data source supplying data to an AI engine interfacing to a user application.

FIG. 14 is a diagram illustrating interaction of modules of the AI system, including trusted data sources.

FIG. 15 is a diagram illustrating another interaction of modules of the AI system, including the trusted data sources.

FIG. 16 is an exemplary flow diagram illustrating a method of source verification according to an embodiment of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Methods and systems are provided for secure and reliable communications in the context of artificial intelligence (AI) systems. The AI systems may include large language models (LLMs) and knowledge bases based on suitable knowledge graphs.

Secure and reliable communications for AI systems may be applicable to any number of fields of use. In some examples, the methods and systems disclosed herein may be applied to any suitable field such as business, government, law, medicine, or finance. For example, in the field of law, hallucinations have caused erroneous case law citations that have negatively impacted litigants cases. In other examples, the methods and systems may be applied to the field of finance, including for of advanced financial products, a mortgage loan, and a fixed index annuity to mitigate risks of default on mortgage loans and at the same time, or in the alternative, solution to chronic risks associated with failure of retirement income preparation due to the psychological pressure of long-term savings. A mortgage loan is typically a loan between a purchaser and lender, used to purchase or maintain a home, land, or other types of real estate. An annuity is typically a form of insurance or investment entitling the investor to a series of payments (usually monthly or annual payments).

In this disclosure, various systems and methods may be used to facilitate the methods described in the preceding paragraphs. In some embodiments, methods and apparatuses may be provided for facilitating the entire process from beginning to end and throughout. In some methods various artificial intelligence methods and apparatuses may be applied to facilitate the methods described. In some examples, any combination of data gathered or generated may be used in the methods. As an example, neural networks (NN), including artificial neural networks (ANN) may be applied to the methods and systems.

A human brain may work in a different manner from that of a computer. While computers may use digital logic and control (e.g., 0s and 1s), the human brain is a slower collection of nodes called neurons. These neurons may be connected by synapses which pass electronic or chemical signals in the brain. These connections may be capable of changing each time information is sent or received representing adaptation and learning. A neutral network may be an artificial computer-generated system that attempts to replicate the neural system of the human brain. Nodes may be used to represent neurons, and they may be connected with different weights that represent the synapses of the neurons. These networks may be trained to process different information and learn from it. Naturally these systems may be used to mimic certain functions that the human brain may be capable of performing, such as pattern recognition and decision making. While the brain may be capable of performing these functions, properties inherent to computers, AI systems, and networks allow computers to transcend the capabilities of human brains in the scale, complexity, etc. of the systems.

Some systems may use any suitable simple neural network logic gates and functional units including the linear threshold gates. In some examples, the neural networks may be described in various ways and forms with some examples including processing units, weights, a computation method, and a training method. In some embodiments, the neural network may include feedforward networks.

Artificial intelligence may refer to the field of studying artificial intelligence or methods for making artificial intelligence, and machine learning refers to the field of defining various issues dealt with in the field of artificial intelligence and studying methods for solving the various issues. Machine learning is defined as a computer algorithm that enhances the performance of certain tasks through experience with tasks and the use of data, and in some cases a large amount of data.

A neural network or artificial neutral network is a model used in machine learning and may mean a model of problem-solving ability which is composed of artificial neurons (nodes) that form a network by synaptic connections. The artificial neural network may be defined by a connection pattern between neurons in different layers, a learning process for updating model parameters, and an activation function for generating an output value.

The ANN may include an input layer, an output layer, and optionally one or more hidden layers, Each layer includes one or more neurons, and the ANN may include a synapse that links neurons to neurons. In the ANN, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the ANN may be to determine the model parameters that minimize a loss function. The loss function may be used as an index to determine optimal model parameters in the learning process of the ANN.

Machine learning may be classified into supervise learning, unsupervised learning, and reinforcement learning according to a learning method.

The supervised learning method may refer to a method of learning an ANN in a state in which a label for learning data is given, and the label may mean the correct answer (or result value) that the ANN must infer when the learning data is input to the ANN. The unsupervised learning may refer to a method of learning an ANN in a state in which a label for learning data is not given. The reinforcement learning may refer to a learning method in which an agent defined in a certain environment learns to select a behavior or a behavior sequence that maximizes cumulative compensation or some type of reward in each state.

Machine learning, which may be implemented as a deep neural network (DNN) including a plurality of hidden layers among ANN, is also referred to as deep learning, and the deep learning is a part of machine learning.

An AI device or apparatus used herein may refer to a machine that automatically processes or operates a given task by its own ability. In particular, an AI device having a function of recognizing an environment and performing a self-determination operation may be referred to as an intelligent device. In some cases, an intelligent device may be referred to as an android or other artificial being. In the disclosure, AI device, intelligence machine, android, artificial machine, may be used interchangeably.

Those skilled in the art will readily recognize that the disclosure is not so limited to the above types and mechanisms of neural networks. In other examples, ANNs such as regulatory feedback networks, radial basis function networks, recurrent neural networks, modular networks, etc. may be used based on user design and preference.

It may be appreciated by those skilled in the art that any of the artificial intelligence features may be used in combination with the methods described herein; in some embodiments, the methods and apparatuses may be practiced without the use of any or all of the artificial intelligence features. It may be appreciated as well that existing methods for financial services are time consuming and require significant manual labor. For example, the process for intake of customer requests and data often requires person-to-person exchanges. As well, some of the process may be error prone due to the manual methods used. The disclosed methods, however, improve on the existing methods and provide for the many benefits including addressing hallucinations, security, reliability, energy efficiency, among other examples.

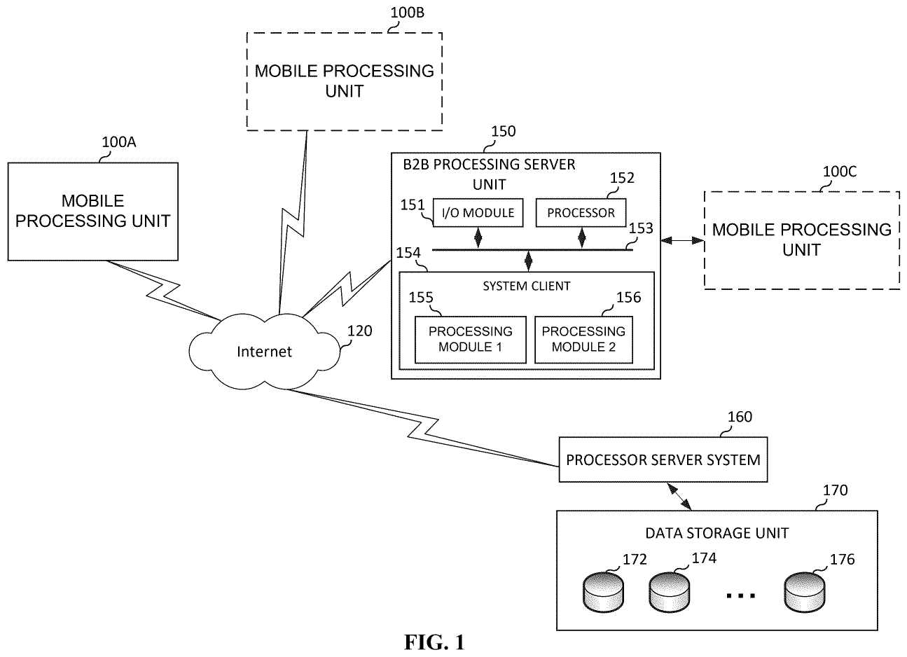

FIG. 1 illustrates an example financial services processing system including mobile processing units 100A, 100B, 100C, a business-to-business (B2B) services process unit 150 (which may also be interchangeably referred to as a B2B processing unit 150 or module 150), a mortgage processor server system 160, and a data storage unit 170, according to an embodiment of the disclosure. While the unit 150 may be called a business-to-business unit 150, it may be appreciated that the unit 150 may be used in any one of various scenarios including between financial companies/organizations, between the companies and end users, or for internal services within the company. In some examples, the processing units 100A-C may be a financial processing units; the processing server unit 150 may be a financial processing server unit; the server system 160 may be a financial processor server system; the modules 155, 156, may be business, financial, legal, etc. processing modules.

In some examples, the unit 150 may be used by end users. Some elements such as mobile processing units 100B, 100C may be optional. Any type of end user may be a user of the mobile process unit 100A. For example, a person seeking an annuity and/or mortgage product may be the user of mobile processing unit 100A. A financial services provider may be the user for B2B financial processing server unit 150. In some embodiments, B2B processing unit 150 may be in communication and/or coupled to another B2B processing unit 150, for example, for inter-company or intra-communication connections. The various units may be coupled via the internet 120, or any other suitable communication link such as satellite links, terrestrial links, wireless links, and the like. The B2B server unit 150 may be coupled to a processor server system 160. The processor server system 160 may be coupled to a data storage unit 170 containing one or more databases 172, 174, 176. In some embodiments, one or more of the databases 172, 174, 176 may contain customer information such as users of the mobile process unit 100A.

B2B server unit 150 may include processor 152, I/O module 151, display screen, camera, one or more speakers, microphone, data bus 153 used for communication between the components, and a system client 154 including a processing modules 155, 156, each of which may be implemented as either a software application and/or hardware component and may be executable by processor 152 to, e.g., facilitate provision of financial services by devices such as device 100A in communication with B2B processing server unit 150 in a financial services system. In some examples, processing modules 155, 156 may be financial module for borrower processing or lender processing. Processor 152 may also operate I/O module 151, display screen, camera, speaker, microphone, in support of the provision of financial services as per instructions provided by system client 154. For example, I/O module 151 may send and receive data to and from the end users of the financial services system; received data may be displayed on display screen; camera may provide video data to be sent to user devices such as device 100A; speaker(s) may play received audio; microphone may provide audio input to be sent to devices such as device 100A. In some embodiments, I/O module 151 may include encryption algorithms to provide secure end-to-end communications and financial services processing with mobile devices or servers units. In other embodiments, a separate module (not shown) coupled to the processor 152 may be configured to provide the encryption algorithms to provide secure end-to-end communications. In yet other embodiments, separate modules or recording devices may be coupled to unit 150 or processor 152 to provide additional capabilities associated with providing services or receiving data from end users.

In accordance with embodiments described herein, processing modules 155, 156 may be implementable either as a software application and/or hardware component that may be implemented as either an integrated component of system client 154 or as an independent module in communication with system client 154. In some examples, processing module 155 may be configured to perform functions associated with intake and offer of financial services including servicing initiate services for mortgagees, such as on device 100A. In some examples, processing module 156 may be configured to perform functions associated with payment and other offers of financial services including payment processing for end users, such as on device 100A.

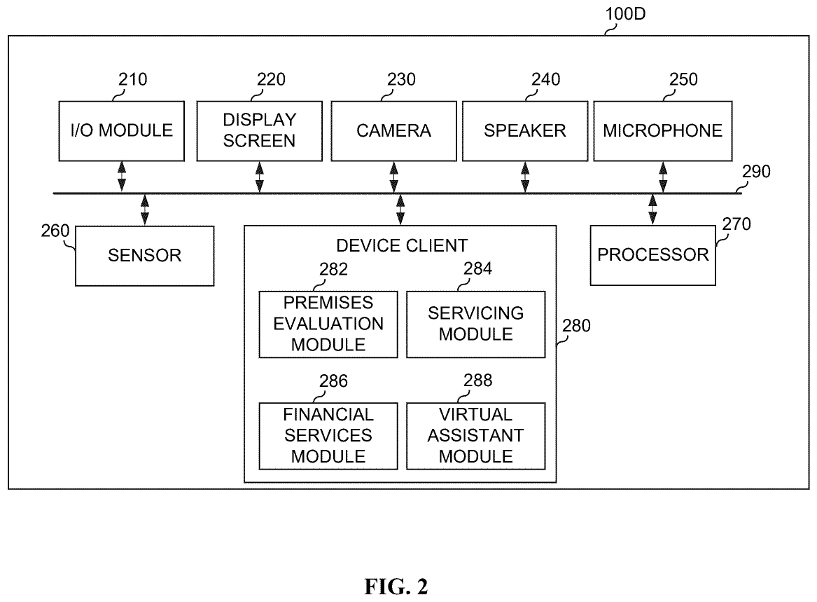

FIG. 2 is an exemplary block diagram of the mobile device or mobile financial processing unit 100A of FIG. 1. Financial processing unit 100D, or simply referred to as device 100D, may include processor 270, I/O module 210, display screen 220, camera 230, one or more speakers 240, microphone 250, sensor device 260, data bus 290 used for communication between the components, and financial processing device client 280, which may be implemented as either a software application and/or hardware component and may be executable by processor 270 to facilitate financial services by device 100D in a financial services interaction or transaction. Processor 270 may also operate I/O module 210, display screen 220, camera 230, speaker 240, microphone 250, and sensor 260 in support of providing financial services as per instructions provided by device client 280. For example, I/O module 210 may send and receive data to and from other devices, e.g., to facilitate financial services between or among the various users and devices such as such as B2B server unit 152 or mortgage processor server system 160 acting as a remote server or to other mobile devices (e.g., a remote device) such as device 100A of FIG. 1. Received data may be displayed on display screen 220; camera 230 may provide video data to be sent to other devices 100D; speaker(s) 240 may play the received audio data; microphone 250 may provide audio input to be sent to other devices; and sensor(s) 260 may read data from or around the user (e.g., a home buyer) of the device 100D to send to one or more of the servers or other devices. In some embodiments, I/O module 210 may include encryption algorithms to provide secure end-to-end communications with other mobile devices or servers units such as server unit 150 of FIG. 1. In some embodiments, financial services may be facilitated using the secure end-to-end communications. In other embodiments, a separate module (not shown) coupled to the processor 270 may be configured to provide the encryption algorithms to provide secure end-to-end communications.

In some embodiments, the financial services processing units may be in communication with each other in a peer-to-peer configuration. For example, two or more end users such as home buyers may use the devices to communicate between themselves or provide peer-to-peer processing to combined processing power. In other embodiments, any combination of server devices and end user devices may be in communication.

In accordance with embodiments described herein, device client 280 may include, e.g., a premises evaluation module 282 (e.g., analysis of a physical location, land, building, house, complex, business office location, and the like), a servicing module 284, a financial services module 286, and a virtual assistant module 288, which in some embodiments may be an AI-enable module. In some embodiments, the premises evaluation module 282 may be implementable either as a software application and/or hardware component that may be implemented as either an integrated component of device client 280 or as an independent module in communication with device client 280. As will be described below, premises evaluation module 282 may be configured to perform premises evaluation routines on the device 100D. In some examples, the device 100D may be used as part of a real estate evaluation process, such as by a prospective homeowner evaluating the suitability of a new property, or may be used as part of the process for securing a loan or other financial instrument regarding the property (e.g., for purchase of the property). It may be appreciated that the device 100D may be used by any category of users including prospective home buyers, those seeking financial assistance or loans, or businesses evaluating a property. In some embodiments, the premises evaluation module 282 may be included on a server unit such as B2B server unit 150 of FIG. 1.

Device client 280 may include a financial service module 286. This module 286 may provide some or all of the traditional financial services, alone, or in conjunction with the various improvements disclosed herein. In some embodiments, the financial services module 286 may be implementable either as a software application and/or hardware component that may be implemented as either an integrated component of device client 280 or as an independent module in communication with device client 280. In some embodiments, the financial services module 286 may provide such functions as payment processing, providing payment reminders, requesting updated biographical or other information of the user to provide to the server unit. In some embodiments, the financial services module 286 may provide services associated with one or both of annuities or mortgage tasks.

Device client 280 may include a servicing module 284. The module 288 may be implementable either as a software application and/or hardware component that may be implemented as either an integrated component of client 280 or as an independent module in communication with client 280. In some embodiments the module 288 may be used as a module 288 for a server, such as server unit 152 of FIG. 1. In some embodiments, the module 288 may be a distributed or centralized, or peer-to-peer module (e.g., using processing power of mobile financial processing units in communication with each other), or any combination thereof. The module 288 may perform any one of the data collection, data generation, training, and model refinement, or application of the model processes.

Client may include a virtual assistant module 288, which in some embodiments may be an AI-enabled module. Virtual assistant module 288 may be implementable either as a software application and/or hardware component that may be implemented as either an integrated component of client 280 or as an independent module in communication with the client 280. As will be described below, virtual assistant module 288 may be configured to perform virtual assistant functions such as interacting with a user (e.g., a prospective/existing financial services customer or a user on the institutional or financial services provider company) of the device 100D. Such interactions, for example, may include answering user queries or questions, and the interactions may include gathering information from the user to send to the module. When the device 100D is used by the customer side (compared to the business side), the virtual assistant module 288 may provide answers regarding financial information or other general provider-side information. Virtual assistant module 284 may work in conjunction with any one of the other modules 282, 284, 286 to determine interactions and provide relevant information and responses to queries.

Virtual assistant module 288 may include software and/or hardware for creating the AI model used to interact with the user. In other embodiments, the AI model may be previously created (e.g., at a dedicated or distributed processing node(s)) with the resulting model copied to the module 288.

In some embodiments, virtual assistant module 288 may be configured to address needs of the user and existing insurance sales representatives or agents.

In one example, the module 288 may be configured to address questions of the user, in some examples based on the user's circumstance. Because it may be difficult to assess what information is and is not relevant for the user, in some examples, it may be best for such a module to reside and run on the user's device. Information associated with the user may be collected during the query session or prior. The information may be collected outside of the device.

In some embodiments, the input may include a set of information or documents including the user's information (profile, or otherwise), and the insurance provider's sets of information. The user's information may include preferences, the current situation of the user, and biographical information. Information may be collected from the user's interactions. In some embodiments, where appropriate, information may be collected based on the user's interactions with the user device-for example, typing, talking, or other activities. In some examples, collected information may be passive/indirect (simple interactions with platform without directly answering or inputting directly related to or associated with the provider's business) or active (direct interactions, e.g., questions about the products, research on products).

In some embodiments, the set of information may be used as input. The set of information may be any combination of the user's data along with insurance data. For example, provider information may include sets of information/documents including documents on insurance polices.

The provider may have information on interactions and outcomes of policies and their effects of each user's habits, behavior, or responses. Each of the information pieces may be used alone, or in combination with the user information. The information may be used as input. They may be tokenized (converted to, i.e., word, character, or phrase-based tokens or any other suitable form/structure).

Once the input is processed, the system may produce a response. The response may provide information and may also be associated with a product/service for the user. The response may proceed along two paths, with one path including user querying regarding the information and the product/services. In some examples, the user may provide additional information to be tokenized.

In case where the response includes an aspect associated with a product/service, information may be sent to the provider. The system may prompt the user for interest in the product/service. Based on the user's response, the system may proceed with the transaction of the product. In some examples, transaction may be switched to a traditional context. In other examples, the transaction may be completed through the AI system. In other examples, the transaction may be referred to the provider to complete the transaction.

Context switching may be used to save costs and/or processing time. A context switch may be stable (i.e., remainder of interactions is in same context unless a further decision is made for another switch, or context switching may be fluid, switch back and forth depending on desire or need for features).

For brevity, in the disclosure references may be made to “product” or ‘service”, however, it should be appreciated that such reference is not limiting that that such references may be applicable to any combination of products and services.

In another embodiment, the system may be provided with a basic/generic neural network. The neural network may be specially trained with special data/information. In some examples, this training may be a single time/occurrence. In some other embodiments, this training may be multiple occurrences. In yet other examples, the training may be progressive-i.e., continuously improved/trained.

In some examples, the training may include reinforcement training (either supervised and/or unsupervised). Because the additional training may require significant resources, there may be a trade-off in resource costs for pre-defined neural network such that some configurations of the system may require additional training whereas other configurations of the system uses a standard system (one-time training) without additional training, but rely on very large inputs during the one training occurrence.

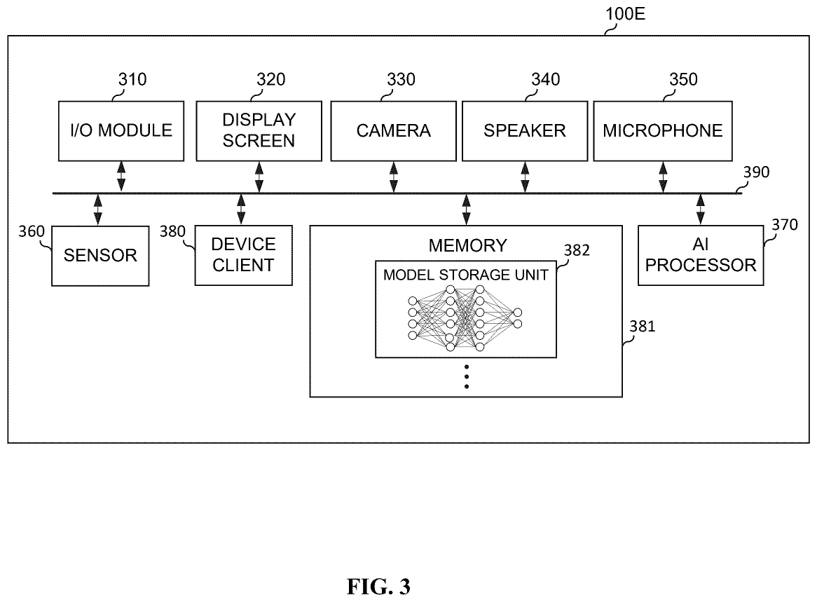

FIG. 3 is an exemplary AI-enabled system that may be the mobile processing unit or device (e.g., 100A of FIG. 1, or 100D of FIG. 2), or the B2B processing server unit (e.g., unit 150 of FIG. 1), or the processer server system (e.g., system 160 of FIG. 1), or a separate system coupled to any one of the units described herein, according to an embodiment of the disclosure. The system may be referred to as processing unit 100E or device 100E. In case the device 100E is device 100D of FIG. 2, the similar components may function similarly, and AI components (e.g., AI process 370) may be used in addition to or in lieu of the similar component (e.g., processor 270). The system may be in communication with and coupled to a cloud network or the internet.

The AI-enabled system may be a device 100E that processes an artificial neural network by using a machine learning algorithm or uses a learned artificial neural network. The AI-enabled system may include or be coupled to a set of servers to perform distributed processing, or in some cases, centralized processing, or cloud-based processing, e.g., over a network. The system may perform any combination of processes associated with the AI functions. As disclosed above, the system may include some similar features and units performing similar functions as those in FIG. 2. Some details for similar components may be omitted for brevity.

Device 100E may include processor 370, I/O module 310, display screen 320, camera 330, one or more speakers 340, microphone 350, sensor device 360, data bus 390 used for communication between the components, and device client 380, which may be implemented as either a software application and/or hardware component and may be executable by AI processor 370 to facilitate, e.g., financial services by device 100E in a financial services interaction or transaction. AI processor 370 may also operate I/O module 310, display screen 320, camera 330, speaker 340, microphone 350, and sensor 360 in support of financial services as per instructions provided by client 380. Device client 380 may be device client 280 of FIG. 2, or may include any or all of the modules 282, 284, 286, 288 or FIG. 2. I/O module 310 may send and receive data to and from other devices, e.g., to facilitate financial services between or among the various users; received data may be displayed on display screen 320; camera 330 may provide data to be sent to other devices; speaker(s) 340 may play the received audio data; microphone 350 may provide audio input to be sent to other devices; and sensor(s) 360 may read data from or around the user (e.g., a home buyer) of the device 100D to send to one or more of the server devices (e.g., server unit 150 of FIG. 1). In some embodiments, I/O module 310 may include encryption algorithms to provide secure end-to-end communications with other mobile devices or servers units (e.g., server unit 150 of FIG. 1). In some embodiments, financial services may be facilitated using the secure end-to-end communications. In other embodiments, a separate module (not shown) coupled to the AI processor 370 may be configuration to provide the encryption algorithms to provide secure end-to-end communications. While AI processor 370 is indicated as an AI component, the component is provided as a non-limiting example. Non-AI processors and components may be used in addition to or in lieu of the AI process 370.

The memory 381 may include a model storage unit 382. The model storage unit 382 may store a learning or learned model (or an artificial neural network) through the AI processor 350. The AI processor 370 may learn the artificial neural network by using the learning data. The learning model may be used in a state of being mounted on one of the servers of the artificial neural network, or may be used in a state of being mounted on an external device such as device 100A of FIG. 1.

The learning model may be implemented in hardware, software, or a combination of hardware and software. The processor 370 may infer the result value for new input data by using the learning model and may generate a response or a control command based on the inferred result value.

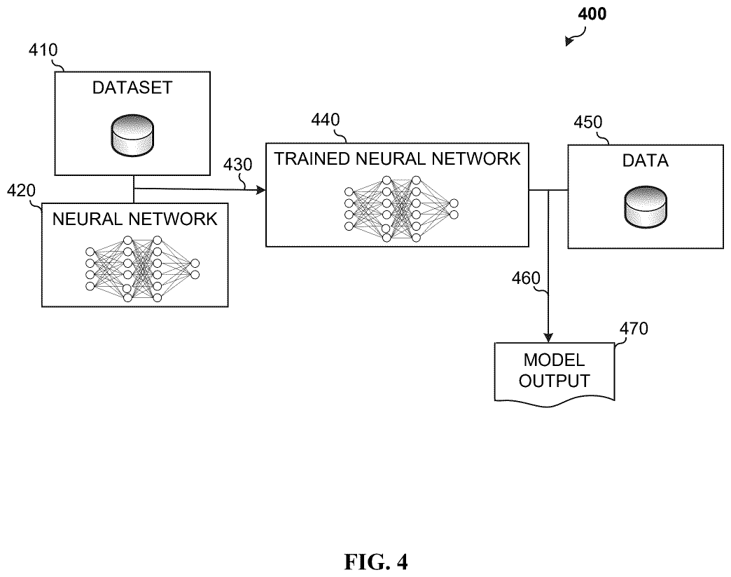

FIG. 4 is a diagram 400 illustrating the process flow for training an AI model using a dataset 410 with a deep neural network 420 including a set of parameters, according to an embodiment of the disclosure. For example, the training may be used on any of the devices such as device 100A of FIG. 1, device 100D of FIG. 2, device 100E of FIG. 3, etc. or server unit 150, system 160 of FIG. 1. For example, the neural networks 420, 440 may be memory storage unit 382 of memory 381 of FIG. 3. Once a given neural network 420 has been structured for a task the neural network 420 is trained using a training dataset 410. It will be appreciated by those skilled in the art that the dataset 410 may be a dataset gathered from real information, or in other examples, may be a generated dataset. Various training frameworks may be developed for the training process 430. The training framework may hook into an untrained neural network 420 and enable the untrained neural network 420 to be trained to generate a trained neural network 440. At the start of the process, the initial weights of the untrained neural network 420 may be chosen randomly or by pretraining using a deep neural network.

The training cycle may then be performed in either a supervised or unsupervised training process 430. Supervised learning is a learning method in which training may be performed as a mediated operation, such as when the training dataset 410 includes input paired with the desired output for the input, or where the training dataset includes input having known output and the output of the neural network is manually graded. The network may process the inputs and compare the resulting output against a set of expected or desired results. Errors may then be propagated back through the process. The training framework may adjust the weights that control the untrained neural network 420. The training framework may provide tools to monitor the progress of the training process is converging toward a model suitable to generate correct answers based on known input data. The training process 430 may occur repeatedly as the weights of the network 420 are adjusted to refine the output generated by the neural network. The training process may continue until the neural network reaches a desired level of accuracy for the trained neural network 440. The trained neural network 440 may be deployed to implement any number of machine learning operations. For example, with the trained neural network, the network may be applied to new data 450 to generate 460 results or output 470 of the model.

Unsupervised learning is a learning method in which the network may attempt to train itself using unlabeled data. In the example of unsupervised learning, the dataset 410 may include input data without any associated output data. The untrained neural network may learn groupings within the unlabeled input and may determine how individual inputs are related to the overall dataset. Unsupervised training may be used to generate a self-organizing map, which may be a type of trained neural network 440 capable of performing operations useful in reducing the dimensionality of data. Unsupervised training may be used to perform anomaly detection, which may allow identification of data points in an input dataset that may represent abnormal readings indicative of certain financial or real estate anomalies including, for example, fraud or defect detection.

In some embodiments, the neural networks 420, 440 may be a large language model (LLM) providing for natural language processing (NLP) tasks. Large language models may use transformer models and may be trained using “big data” or very large datasets that are too large to process using either manual processing or traditional data processing methods. This may enable the LLMs to recognize, translate, predict, or generate text or other content. In the example of FIG. 4, the neural network may be an LLM 420. In some examples, the dataset for an LLM may be labeled or unlabeled data. After the training process 430, the trained neural network (LLM) 440 may be fine-tuned with another (e.g., smaller) dataset that may be labeled (or in some cases unlabeled) for fine tuning. In other examples, the training process 430 may be iterative to produce improved results. For use with the LLMs, information may be decomposed into units called tokens. In some examples, the tokens may be, or may include, words, character sets, combinations of words and punctuation. In other examples, the tokens may be, or may include, sounds, imagery, and the like.

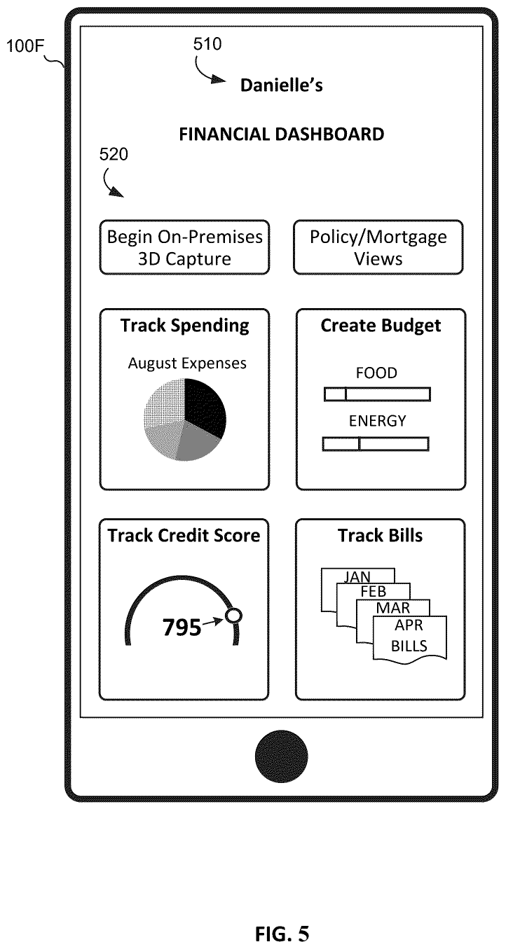

FIG. 5 is an exemplary diagram illustrating a display screen of a mobile device 100F showing a dashboard view of available functions, according to an embodiment of the disclosure. For example, the mobile device 100F may be a mobile financial processing unit 100A, or the B2B financial processing unit 150. In some examples, the mobile device 100F may be a mobile tablet device, smart phone, wearable device, etc. The example dashboard screen on the mobile device 100F may include a personalized header or title 510 such as “Danielle's Financial Dashboard.” Various features 520 such as 3D capture, policy or mortgage views, tracking spending, creating a budget, tracking credit score, or tracking bills may be shown on the screen of the mobile device 100F. Not all available features may be visible or available to all users. As may be suitable for mobile device applications, the screen and features may be customized to the user's preferences.

It will be appreciated by one skilled in the art that any of various dashboard or other types of views may be available and presented to the user.

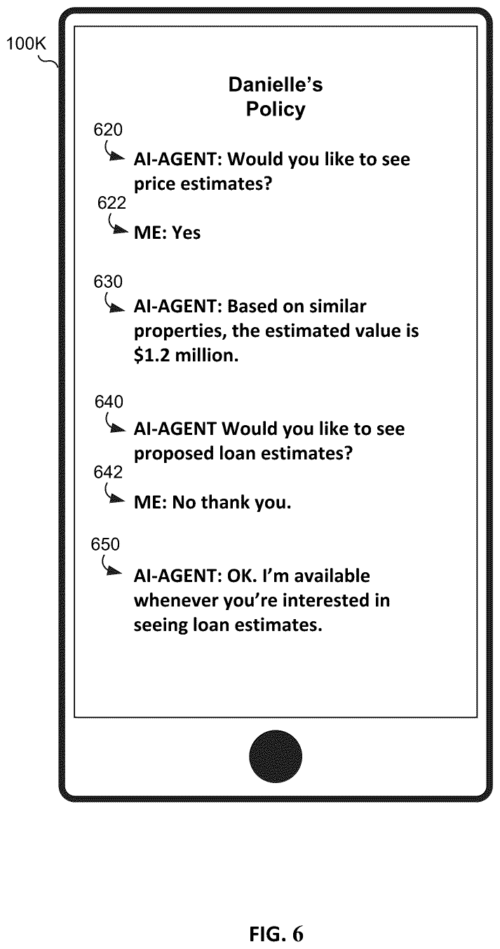

FIG. 6 illustrates an example device 100K query screen including prompts and responses from a user, according to an embodiment of the disclosure. The AI prompts may be generated in response to user inputs, including for context-related questions and prompts while viewing other views such as those in FIG. 5. In other examples, the query screen may be presented in response to other triggers, or spontaneously without any triggers. In some examples, the query screen may relate to medical, legal, or financial products available based on information associated with the user and/or a property visited by the user sent to a remote server. In some examples the query screen may provide a set of prompts for the user of the device 100K. In the example shown in FIG. 6, the AI agent or “AI-Agent” (e.g., a system client such as client 280 of FIG. 2 or client 380 of FIG. 3, running on the device). The AI agent may prompt, at label 620, the user if the user “would like to see price estimates” associated with a property. Based on information associated with the property, the AI agent may provide information at label 630 on the estimated value if the user responds at label 622 in the affirmative. The AI agent may prompt at label 640 the user if the user “would like to see proposed loan estimates” associated with a property. If the user responds in the affirmative, the AI agent may present various proposed loan estimates. If the user responds at label 642 in the negative (as shown in FIG. 6), the AI agent may avoid showing any such proposed loan estimate. The AI agent may display at label 650 an indication that the AI agent is available as the user's request. The available loan information may be stored on the device 100K and available for viewing at a later time upon request of the user.

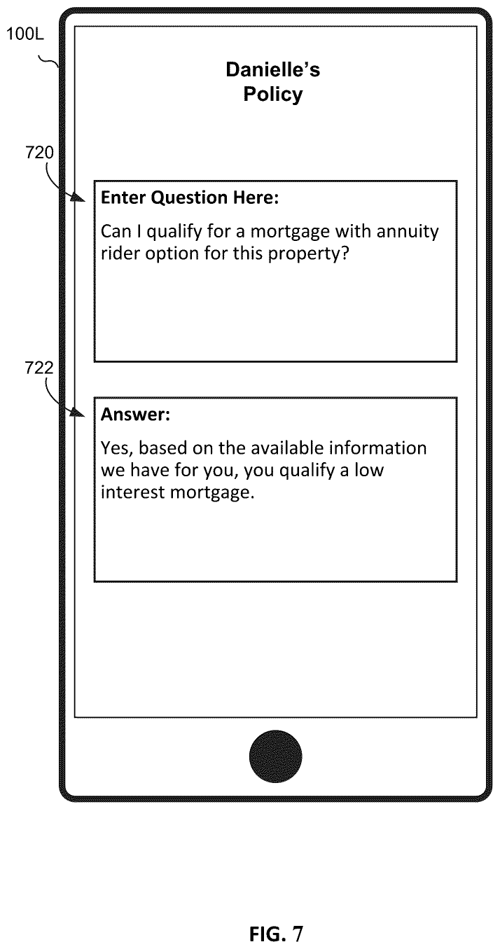

FIG. 7 is an exemplary diagram illustrating a display screen of a mobile device 100L showing question panel 720 and answer panel 722, according to an embodiment of the disclosure. In some embodiments, this screen may have similar functionality as the AI agent screen in FIG. 6, with the example of FIG. 7 providing a client-driven chat, conversation, or exchange; in other words, the example of FIG. 6 beings with prompts from the AI agent, whereas the example of FIG. 7 may allow the user to initiate and control the chat session. In some examples, the question panel 720 and answer panel 722 may use the AI agent module; in other examples, the feature may use real human agents to provide responses in the answer panel 722.

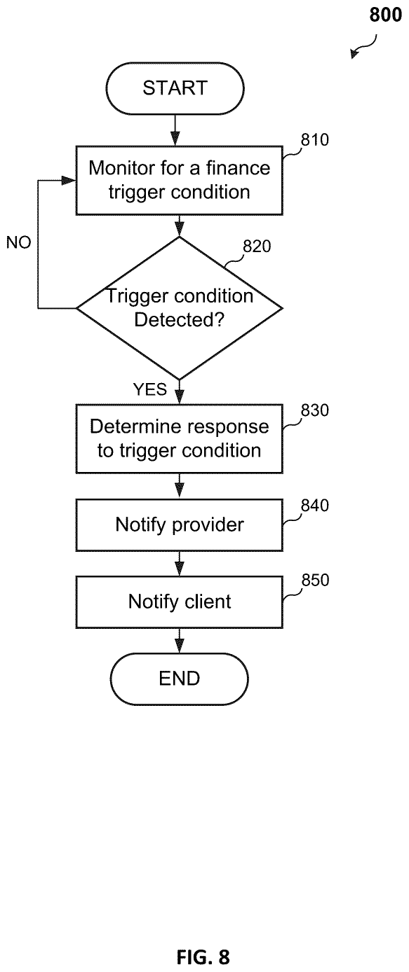

FIG. 8 is an exemplary flow diagram 800 illustrating a method of monitoring a user status or condition, according to an embodiment of the disclosure. The monitoring method may be performed by device 100A of FIG. 1. In some embodiments, it may be desirable to monitor a user condition or status (such as a legal, medical, or financial condition) or other type of situation or condition to determine if an event (e.g., such as a default on a mortgage) may become more likely. In such scenario, it may be desirable to detect these conditions prior to their occurrence to take precautionary measures. Such precautionary measures may include a suitable response such as requesting additional contributions in capital to anticipate the likely default, alerting the user of the possible default and the detected trigger conditions. In some examples, the method may be based on a trained neural network such as network 440 of FIG. 4, e.g., with inputs as data 450 provided to the neural network 440 to derive an output 470 that is a response to the input.

The method may be methods of the clients from the devices such as device 100A or unit 152 or system 160 of FIG. 1, device 100D of FIG. 2, device 100E of FIG. 3, etc. Starting at step 810, the method may include monitoring for a finance trigger condition. The method may include, at step 820 detecting a trigger condition. A trigger condition may be any one or a set of events of changed attributes of the user including, for example, changes in income, career changes, family situations, credit score changes, etc. If a trigger condition is detected, the method may progress to step 830. If a trigger condition is not detected, the method may return to step 810 to continue monitoring for trigger conditions. In other embodiments, the method 800 may end if no trigger condition is detected. The method, at step 830, may determine a response if a trigger condition is detected. The response may be any one or more of a suitable response. The response may include, for example, requesting additional contributions in capital to anticipate a likely default on a loan, alerting the user of the possible default and the detected trigger conditions, etc. The method, at step 840, may include notifying the provider (e.g., the provider of a mortgage loan to the user). Step 840 may be optional in some examples. The method, at step 850, may include notifying the client (e.g., the mortgagor or borrower of a mortgage loan). For example, the method may include notifying the client of the precautionary measures to be taken. In some examples, additional steps may be provided if the precautionary measures require action be taken on the part of the client.

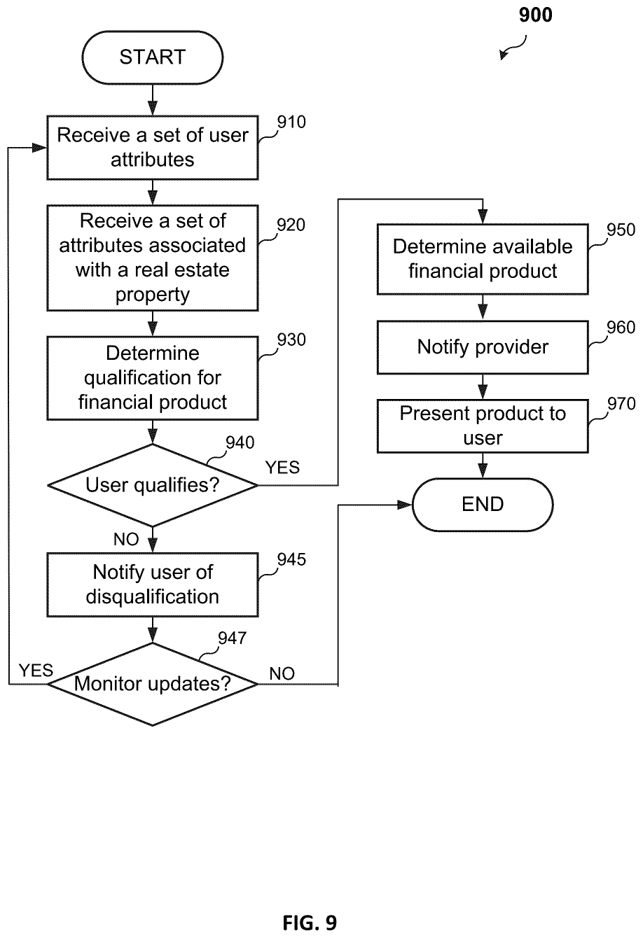

FIG. 9 is an exemplary flow diagram 900 illustrating a method of determining available products for a prospective user, according to an embodiment of the disclosure. The method may be methods of the clients from the devices such as device 100A or unit 152 or system 160 of FIG. 1, device 100D of FIG. 2, device 100E of FIG. 3, etc. The method may include, at step 910, receiving a set of user attributes. The method may include, at step 920, receiving a set of attributes associated with a real estate property. The method may include, at step 930, determining qualification for a financial product (e.g., a loan) based on the information of step 920 and step 930. The method may include, at step 940, determining whether the user qualifies for one or more financial products. If the user qualifies for any one of the financial products, the method may proceed to step 950. If the user does not qualify for at least one financial product, then the method may proceed to step 945. The method may include, at step 945, notifying the user of disqualification for a financial product. After step 945, the method may include, at step 947, determining whether to monitor for updates. In some examples, it may be desirable to monitor for updates (e.g., changes in the user and/or real estate property attributes) that could change the qualification outcome to the determination at step 930. If no monitoring is desired, then the method may end. If monitoring is desired, then the process may return to step 910 to restart the process. In other embodiments, if the monitoring is desired, the method may proceed to step 930 (instead of proceeding to step 910) to quickly reassess the user's qualification for the financial product.

Returning to step 940, if the user qualifies then the method may proceed to step 950. The method may include, at step 950, determining the available financial products and suitable conditions for such financial products. The method may include, at step 960, notifying the provider (e.g., the provider of a mortgage loan to the user). The method may include, at step 970, presenting the product or products to the user. In some examples, additional steps may be provided to complete the process for providing the financial product or products to the user. For example, the user may need to tender additional information, sign forms and agreements, and make payments for the products. The method may end after step 970.

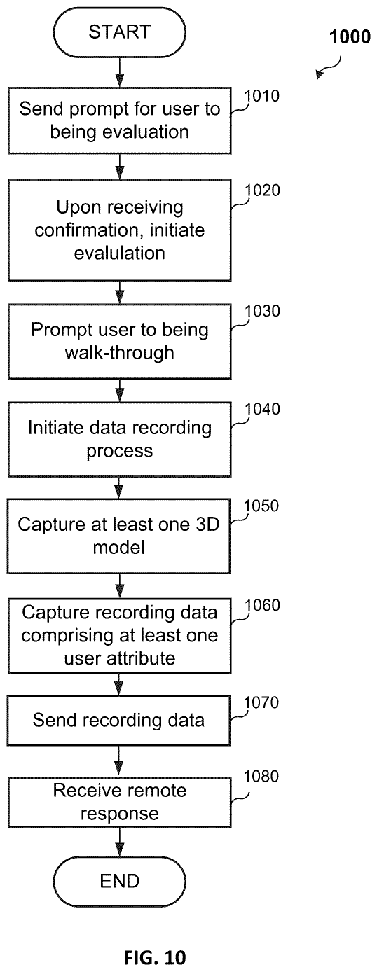

FIG. 10 is an exemplary flow diagram 1000 illustrating a method of the provision of services, according to an embodiment of the disclosure. The services device may be the device 100A of FIG. 1. The method may be methods of any of the system clients from the devices. Starting at step 1010, the method may include sending, to a display of the device, a prompt for a user to begin an on-location premises evaluation. For example, a user may be at a real estate property location that the user desires to purchase. At step 1020, the method may include upon receiving, from the user interface of the device, confirmation from the user to being the evaluation, initiating the on-location premises evaluation. At step 1030, the method may include prompting the user to begin a walk-through of a structure associated with the premises. At step 1040, the method may include initiating, at the device, a data recording process to capture at least one of a dimension measurement and imagery information of the premises. At step 1050, the method may include capturing at least one of a 3D model, a dimension measurement of the structure comprising at least one inside dimension and one outside dimension; at least one room quantity. At step 1060, the method may include capturing the recording data comprising at least one user attribute comprising at least one of a demographic and user preference attribute. At step 1070, the method may include sending, to a remote server, the recorded data. At step 1080, the method may include receiving, from the remote server, a response comprising at least one of a numerical assessed valuation.

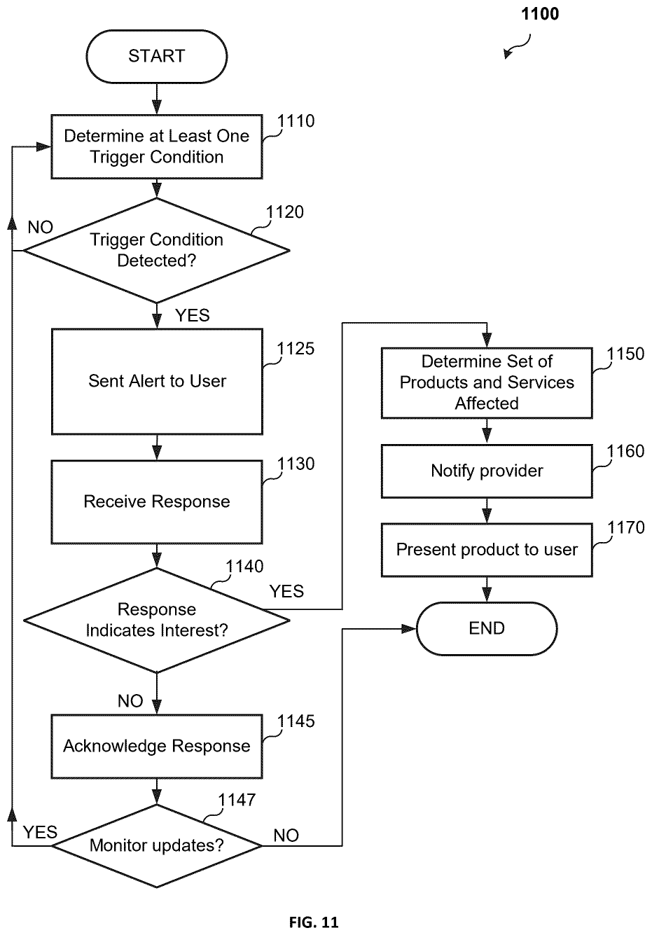

FIG. 11 is an exemplary flow diagram 1100 illustrating a method of detecting a trigger for a changed condition of the user. The device may be the device 100A of FIG. 1. The method may be methods of any of the system clients from the devices. In some examples, the trigger may be detected with or without the LLM. Because it may be cost or process intensive, in some examples, detection of changed circumstances may be determined without the use of processing by an LLM. For example, conventional (non-AI) routines may be used to monitor for trends and keywords. For example, when the user changes jobs, their income may qualify the user for improved benefits. In such instances, it may be beneficial for the user to change their policy or purchase additional products/services.

Starting at step 1110, the method may include detecting a trigger condition. A trigger condition may include any one of a relevant change in information, whether within a dataset or comparing prices of data in a dataset to real life conditions. In some examples, the step may include monitoring trends on social media, user's information including their circumstances and life events (e.g., new job, moving to a new city, etc.) to detect a trigger condition. The trigger condition may be associated with an insurance policy condition. In some examples, any combination of the user's information, available insurance products and services, and current public or private information may be used as input for the trigger. Any condition may be set as a trigger condition. As an example, the financial condition of the user may be evaluated against insurance products/services.

Starting at step 1120, the method may include determining whether a trigger condition is detected. If a trigger condition is detected (“yes” path), then the method may proceed to step 1125. If the trigger condition is not detected (“no” path), then the method may return to the beginning of the loop at 1110. In some embodiments, if no trigger condition is detected at step 1120, the method may terminate.

In some embodiments, the method may processing in a so-called AI-context or conventional context. Because training and running LLMs or other AI models may be resource intensive, some or all of the steps may include running more conventional processing algorithms. Where the method calculates or determines an output using AI methods, the process may be called the AI-context or switching to an AI-context. For example, once a condition is detected, the condition may be formatted for processing through the AI models, with such formatting including preset scripts (e.g., a predefined set of tokens). In other examples, the method may use AI-context for some or all of the steps. In yet other examples, he method may switch back and forth between the AI-context and conventional context as appropriate. In some embodiments, a decision to use the AI-context may be based on cost considerations; the decision may also be based on processing efficiency or speed considerations. Once the method is switched to an AI-context, the method may proceed with AI-context processing.

The switch to an AI-context may be predetermined or may be context and/or situation dependent. If no clear answer is given. In some examples, if conventional process does not detect a trigger condition, then the method may use the AI-context as a fall back mechanism.

In some embodiments, control over the context switching may be provided between so that a method may be suitable transitioned between the AI-context and conventional context. In some embodiments, the decision to switch may be based on any of the following: lack of adequate user responses, always, never, manual input (e.g., from user input or from a server determination, or from a services/product provider). In some embodiments, the context switch itself may be facilitated by AI-enabled features. The provision of information, selection of tokens or set of information selection may be based on a latest set of information that is currently available.

At step 1125, the method may include sending a message to the user including information associated with the trigger condition. In some examples, the message may include notifying the user and/or offer of an option to change/purchase a product or service. In some examples, the message may be informational.

At step 1130, the method may receive a response message from the user in relation to the alert or message sent at step 1125. In some examples where the message at step 1125 is purely information, the method may terminate without proceeding to steps 1130 and beyond.

The response at step 1130 from the user may be used as a prompt for a chatbot or the AI system. This may generate output for the user. In some embodiments, the user may carry on a chat session with the system in association with the generated output. In this example, the chat sessions may be considered AI-initiated because the method automatically monitors for the changed condition (e.g., trigger condition) that started the process for the chat session.

As an example, a user may receive an inheritance (a trigger condition) of money which is detected by the method through any input (e.g., voice or text input); the method sends an alert to the user that this change in conditions entitles the user to many suitable products or services (such as enhances mortgage or annuity products). If the user is uninterested in responding or unable to do so, the method may simply terminate after sending the alert. If instead, the user is interested in learning more about the implications of the changed conditions or in the services/products offered, then the user may continue the chat session. While the method is described as a chat session, those skilled in the art will recognize that any suitable continuation of communication may be provided, including other forms of communication such as email or telephone follow up.

After the method sends the message to the user, method may wait for the response at step 1140 to determine whether the user response indicates an interest in the alert message. For example, the user may have interest in learning more about the implications and effects of the changed condition.

If the method at step 1140 determines that the response indicates an interest, then the method may proceed to step 1150. If the method at step 1140 determines no interest from the user, then the method may proceed to step 1145. At step 1145, the method may acknowledge the user response, and then proceed to step 1147. At step 1147, the method may determine whether to continue monitoring for trigger/changed conditions or for updates from the user. If the method at step 1147 determines not to monitor updates or trigger/changed conditions, then the method may terminate. If the method at step 1147 determines to continue monitoring, then the method may loop back to step 1110.

Returning to step 1140, if the method determines the user is interested in the alert message, then the method may proceed to step 1150. At step 1150, the method may determine a set of products and/or services affected by the trigger condition At step 1160, the method may notify a provider (e.g., a service or producer provider) associated with the set of products and services affected. In some examples, a cascade of products and services (either new or existing) may be affected by changes in a person's current situation.

At step 1170, the method may present any set of available products and/or services to the user. In some examples (not shown), the method may continue to determine whether the user has a desire to engage with the product and/or services.

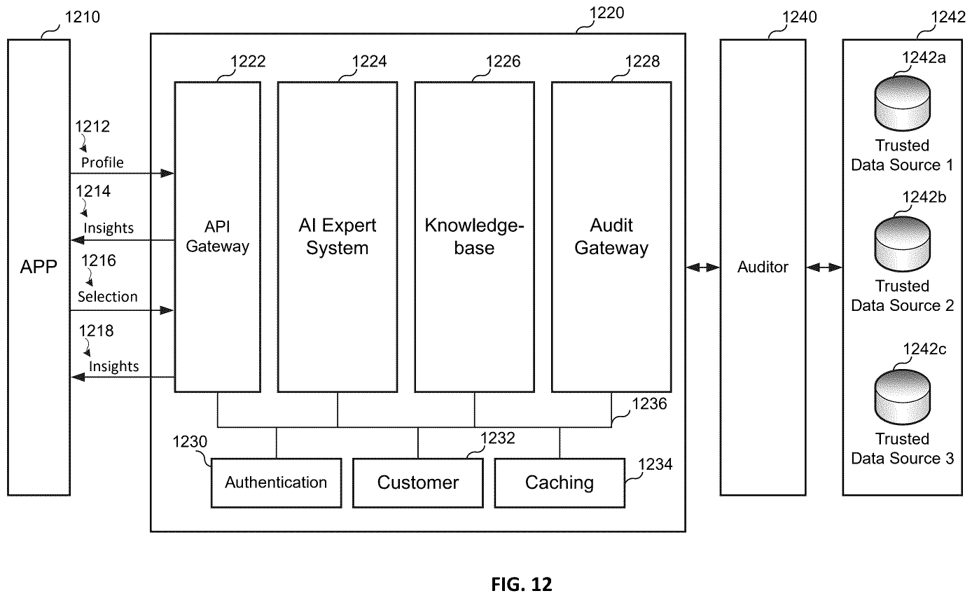

FIG. 12 is an exemplary block diagram of a system including a trusted data source supplying data to an AI engine interfacing to a user application. The system may include an application 1210 or an application layer for interfacing with a user of the system. The system may include an AI-application 1220 or AI-layer using a knowledge graph (that may be a part of AI expert system 1224) and knowledge base 1226. The system may include an auditor 1240 and a trusted data source 1242. This configuration may provide for a system for automated generation of output with trusted data (e.g., from the trusted data source), addressing previous problems associated with hallucinations and other undesirable artifacts of interfacing with AI and LLMs.

In the example of FIG. 12, the application 1210 is in communication with the AI-application with example communication or messages exchanged between the user application 1210 and AI-application 1220 by way of an application programming interface (API) gateway 1222. The gateway 1222 may provide an interface specification, which may be embodied in an open source or closed source specification.

An example exchange may include the user sending a message 1212 including profile information of the user such as gender, age, health habits like tobacco and alcohol usage, downpayment or financial credit. The exchange may include a response from the AI-application of a message 1214 including insights for the user. The message 1214 may include estimated insights in response to the profile information sent from the user. In some examples, estimated insights may include information for user benefits. In an example, the message exchange may include the user sending a question or query to the AI-application, asking for information for either new or existing contract (e.g., an annuity policy) for the user. The user may send the profile information along with the question. In other examples, the AI-application may have previously acquired the profile information directly or indirectly from the user.

Message 1216 may include information for the user's selection of an option (e.g., a product) based on the prior exchanged messages 1212, 1214. For example, the user may have inquired about financial products with the system providing a set of products suitable for the user. In message 1216, the user may select one or more of the products. Message 1218 may include sights in response to the selection in message 1216. The insights may include visual (e.g., numerical and description) insights associated with the selection. In an example, the insights include a description of a financial product and the application of the product to the user. The description may include all reasonable inferences and deductions based on the user's previously provided profile information.

The AI-application 1220 may contain the API gateway 1222, AI expert system 1224, knowledgebase 1226, and audit gateway 1228. The AI expert system may be the module including an encoded model. In some embodiments, the AI expert system may include processing modules such as an encoder system, decoder system (or decoder network). In some embodiments, the AI expert system may include data and data structures such as a hidden system, description data, numerical data, and a knowledge graph. This description should be understood as exemplary and not limiting. For example, the types of data are not so limited. In other embodiments, any suitable type of data, whether represented in text, numerical, binary, or 3D representations may be used as appropriate.

The knowledge base 1226 may include any suitable type of data for the application. In some examples such as a financial institution, the knowledgebase 1226 may include data such as real property information, financial product specification information, financial product questions and answers (Q&A), customer beneficial use cases, and simulation data. In other examples, the data may include analytical information associated with calculations of financial information applied to users.

Returning to FIG. 12, the system may an audit gateway 1228 configured to avoid hallucinations and other undesirable artifacts of AI systems. The audit gateway 1228 may include a source verification module configured to determine and validate the source or origin of the information. Source verification may be important, e.g., for financial transactions to ensure the relevant or counterparties are valid. The audit gateway 1228 may include a content filtering dictionary, a regulation dictionary, and AI prompt dictionary for the filtering.

The AI-application 1220 may be in communication with an auditor 1240 configured to handle information from the data sources 1242. While an auditor 1240 may be offline manual review of the trust data, in some embodiments, the auditor may be any combination of manual and automated validation of the trusted data sources 1242. The trusted data sources 1242 may represent data and sources originating from high-quality sources or sources with validated financial reputation. For example, the trusted data sources 1242a, 1242b, 1242c may include data from consulting firms, product experts, sales experts, etc.

The system may include modules providing features of the AI-application. In some examples, the modules may include an authentication module 1230 for validating the user. The modules may include a customer module 1232 for maintaining, gathering, and processing customer information. The modules may include a caching module 1234 configured for exploiting the advances of proximity of space and time associated with collection of data. In other examples, the modules may include a contract management module, a product management module, associated information module, asset management module, simulator module, load balancing module, and a managed AI platform.

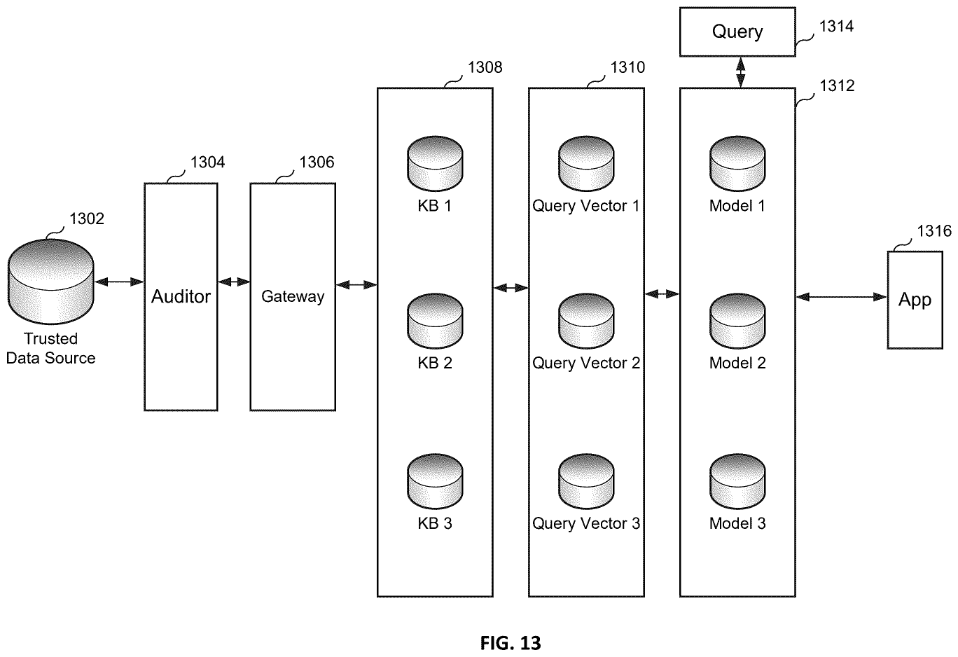

FIG. 13 is another exemplary block diagram of a system including a trusted-data source supplying data to an AI engine interfacing to a user application. The system may include a layered structure for providing the trusted system including a vector database pool.

The system may include a trusted data source 1302. In some examples, the functions of the components may be similar to those of FIG. 12. Auditor 1304 and a gateway 1306 may provide an interface between the trusted data source 1302 and the knowledgebase 1308 module containing data from knowledgebase structures.

This database structure may be designed to store and manage high-dimensional vector embeddings, which may provide AI agent's ability to process and understand complex financial data and user queries. The multi-purpose nature allows for diverse applications, while the “trusted” aspect may emphasize robust security and data integrity measures. For example, user may send queries 1314 to the system to retrieve data from the trusted vector database pool. Based on the query 1314, the system may retrieve data through the various layers including the model layer 1312, the query vector layer 1310, and the knowledgebase layer 1308. Insight responses may be sent to the user application 1316.

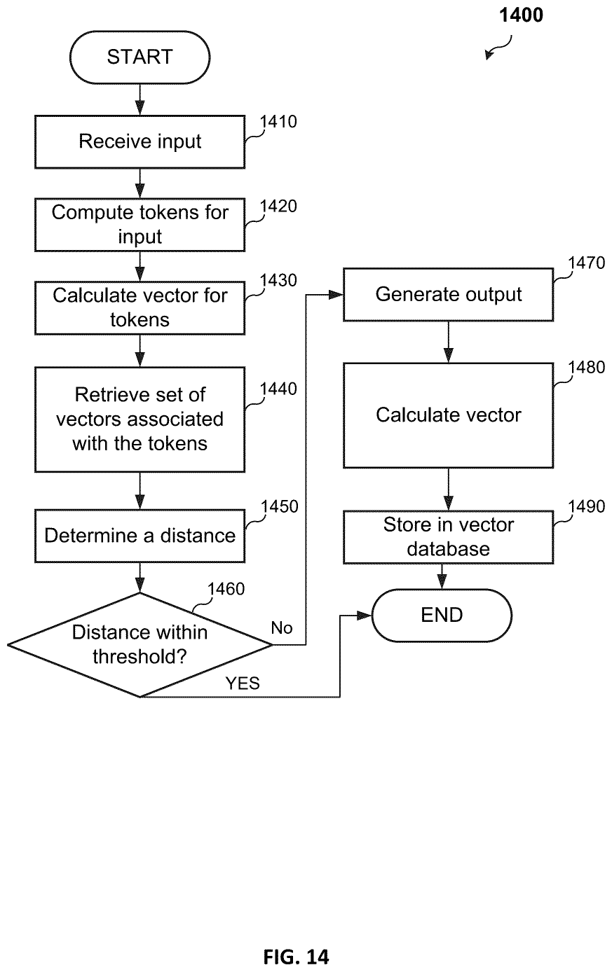

FIG. 14 is a diagram illustrating interaction of modules of the AI system, including the trusted data sources. The diagram shows generation of output tokens in a trusted platform using either a knowledge graph or an LLM.

The method may be a method of device 100E of FIG. 4. The method may be a method of module 370 of the device 100E.

At step 1410, the method may include receiving an input. The method may receive input from a user device, and the input may be any suitable type of input including text, voice, gestures. The input may represent a query, a question from the user.

At step 1420, the method may include computing a token for the input. The step may be called tokenization. Tokenization may be performed based on an suitable set of tokens such character or sub-word tokenization. In some examples, the tokenization may be based on an optimization of the specialized corpus (e.g., of data gathered through users of the device).

At step 1430, the method may include calculating a vector for the tokens.

At step 1440, the method may include retrieving a set of vectors associated with the token. At step 1450, the method may include determining a distance or set of distances. In other embodiments, one or more other criteria may be determined. Other example criteria may include a similarity score between the data. A word score based on the tokens or vectors. In yet other embodiments, the criteria may be user-defined.

At step 1450, the method may determine a distance between the calculated token and retrieved set. The distance may be a vector distance or other metric between the data.

At step 1460, the method may determine whether the distance is within a threshold value. In an example, the threshold value may represent a similarity of the results or data. If the distance is within the threshold value, then the retrieved results may be used, and the method may proceed to terminate.

At step 1470, the distance to the retrieved set of vectors is not within the threshold, and the method proceeds to generate output based on the receive input from the user.

At step 1490, the method may store the vector in a database.

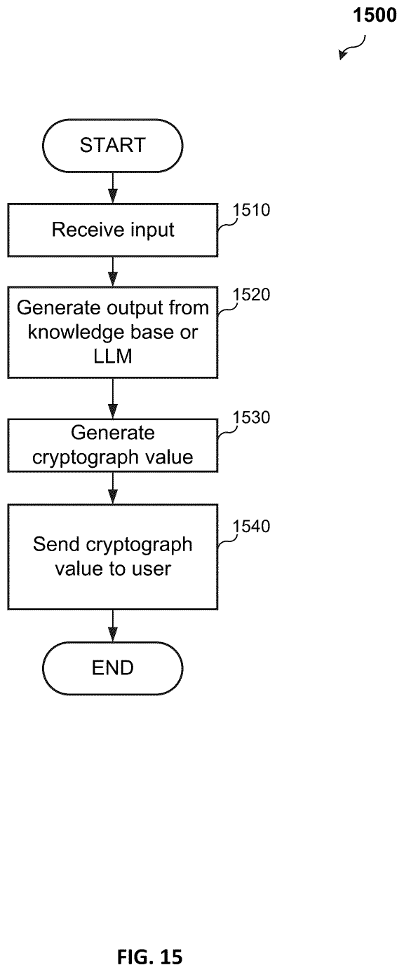

FIG. 15 is a diagram illustrating another interaction of modules of the AI system, including the trusted data sources. The diagram shows generation of output tokens in a trusted platform using either a knowledge graph or an LLM. In some embodiments, the method may provide for secure and reliable communications using the AI system. For example, the method may use cryptographic methods to provide encrypted or encoded messages. For example, the method may provide an integrity check for output, with integrity values such as a checksum, digest, or hash value.

The method may be a method of device 100E of FIG. 4. The method may be a method of module 370 of the device 100E.

The method, at step 1510, may include receiving input from a user of the device. The method, at step 1520, may include generating output from a knowledge base or LLM in response to the input.

The method, at step 1530, may include generating a cryptographic value. Generating the cryptographic value may include one or both of creating an encrypted message based on the generated output, or creating an integrity value to be sent with the value. In some embodiments, at least one cryptographic key may be used in conjunction with the method. For example, public key or private key schemes may be used. Such public or private keys may be shared beforehand as “pre-shared” keys.

In some embodiments, the LLM itself may be used as the basis for generation of the cryptographic keys and values. For example, outputs of the LLM may be used as the cryptographic key values, or the outputs of the LLM may be mapped to checksum or hash values with these values used for purposes of the cryptographic algorithms.

The method, at step 1540, may include sending the cryptographic value to the user.

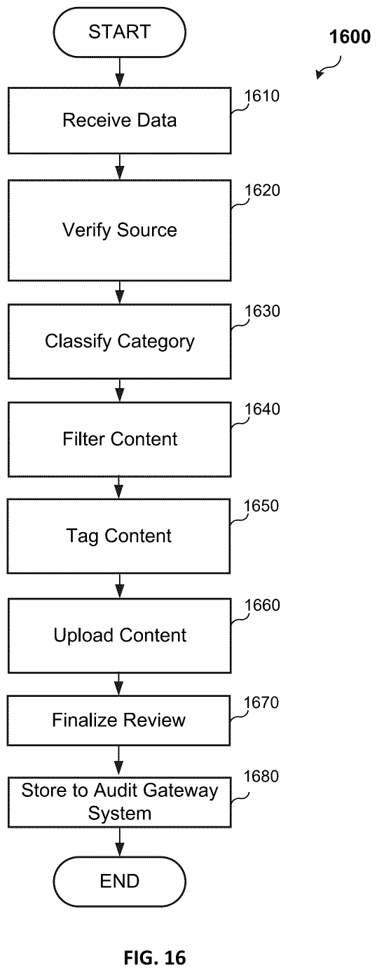

FIG. 16 is an exemplary flow diagram 1600 illustrating a method of source verification according to an embodiment of the disclosure. The method may be performed by device 100A of FIG. 1. The method may be methods of any of the system clients from the devices.

The method, at step 1610, may include receiving input data. The input data may be digital data such as a portable document format (PDF) file, text file, sound, image, or any other suitable type of data. The method, at step 1620, may proceed to verify source of the data. Step 1620 may include any suitable verification check process, including a manual or an automated process or a combination of the two. The verification process may include verifying a source indicator of the input data. In some embodiments, the indicator may be a Uniform Resource Identifier (URI) including an Internet web domain. The method may store a database of verified content sources (such as a white list of web domains) for verifying the source of the input data. In other embodiments, the method may cross check the domain using various sources without a pre-stored database. In some embodiments, the source may be a known repository or other previous verified content source. Any type of indicator associated with the source may be used for verification. While the case of a URL may use pattern (text) matching, in other embodiments, a digital signature of the source may be used for verification.

The method, at step 1630, may provide category classifications for the data. Example data classifications may include providing a functional, hierarchical, or economic, etc. classification.

The method, at step 1640, may include filtering content of the input data. In an example, image data may include inappropriate content such as lewd visual imagery. In another example, text data may include inappropriate content, such as explicit text, factually incorrect, or false information. The filter may include one of removing undesirable portions of the content or providing an indication of the filter content (without removal of the underlying content information within the input data), or any combination including with other suitable filtering mechanisms. In some embodiments, step 1640 may include application of a filtering word dictionary. Such a dictionary may include any suitable list or database of words. In some embodiments, step 1640 may include application of a regulation dictionary such as a compliance dictionary, including in finance, health, legal or other suitable contexts. Such a regulation dictionary may be based on an any industry, business logic or other suitable source.

The method, at step 1650, may include tagging the content. In some embodiments, the input data may be partitioned, compartmentalized or segmented into appropriate bits or sections of data, with the bits or sections being tagging accordingly. In an example, text for a financial transaction may include multiple pieces of information for the transaction. For example, the multiple pieces may include factual bits of data such as a transaction price, date, parties involved. The text may additionally include non-factual narrative or persuasive elements. Each of the portions of data may be tagged, such as “financial data”, “cost”, “biographical,” “narrative” or any other suitable labels for the data. In another example, visual imagery may include many elements, with each element of the imagery tagged based on the type of content.

There may be overlap between steps 1630 and 1650. In some embodiments, step 1630 may be directed toward a higher-level classification of the data whereas step 1650 may be directed toward a lower-level classification of the data. While the method shows two step involved, the disclosure is not so limited, and other embodiments including fewer or more steps and classifications or tagging steps and processes may be involved. For example, the input data may be arranged or sorted into finer levels of granularity.

The method, at step 1660, may upload the content, e.g., to a server.

The method, at step 1670, may include finalizing review of the input data. The final step may include any number of suitable processes including a validation of any one or more of the prior steps. Step 1670 may include one of a manual or automated process. In some embodiments, the final step may include creating a hash of the data.

The method, at step 1680 may include storing the data to an audit gateway system. The storage of data may include storing the received data or portions thereof with the various elements of the method including the categories, filters, and tags.

Some portions of the detailed descriptions above may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proved convenient at times, principally for reasons of common usage, to refer to these signals as bits, values, elements, symbols, It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving, ,” “storing,” “detecting,” “retrieving,” “granting,” “performing,” “locking,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specifically constructed for the required purposes, or it may be general purpose computer system selectively programmed by a computer program stored in the computer system. Such a computer program may be stored in a computer readable storage medium, such as, but not limited to, any type of disk including optical disks, CD-ROMs, DVD-ROMs, Blu-ray disks, magnetic-optical disks, read-only memories (ROMs), random access memories (RAMs), EPROMs, EEPROMs, magnetic-optical disk storage media, optical storage media, flash memory devices, solid state devices, other type of machine-accessible storage media, or any type of media suitable for storing electronic instructions, each coupled to a computer system bus.

The algorithms and displays presented herein are not inherently related to any particular computer or other apparatus. In some embodiments various general-purpose systems may be used with programs in accordance with the teachings herein, or it may prove convenient to construct a more specialized apparatus to perform the required method steps. The required structure for a variety of these systems will appear as set forth in the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method implemented on AI-enabled server device, the method comprising:
receiving a query of a user of the AI-enabled device, wherein the query comprises data and a source indicator;
determining whether the source indicator matches an entry in a trusted database;
upon determining the source indicator matches an entry, assigning at least one classification to the data;
determining a filter mask for the data;
selectively filter the data based on the mask;
creating a set of data tags for the data;
selectively applying the set of data tags to the data;
creating a hash of the filtered data and the associated tags; and
storing the hash with the filtered data and the associated tags to the trusted data storage.

2. The method of claim 1, further comprising:
retrieving a set of values associated with the query, prior to generating an output of the query using a knowledge base or a large-language-model (LLM);
determining whether any value in the set of values is within a threshold value;
upon determining at least one value within the threshold value:
sending the value as an output to the user;
optionally, incrementing a usage statistic associated with the value; and
upon determining that no value is within a threshold value:
generating an output of the query using the knowledge base or the LLM;
calculating at least one of a hash value, a checksum, or a vector for the output;
storing the at least one of a hash value, a checksum, or a vector with the output as a value of the query;
optionally, initializing a usage statistic associated with the value;
sending the output to the user.

3. The method of claim 2, wherein calculating the checksum comprises:
providing a seed value or salting the checksum algorithm together with the value.

4. The method of claim 3, further comprising validating the output of the query prior to storing the output.

5. The method of claim 2, further comprising:
determining whether the output is associated with information outside of the knowledge base or LLM;
upon determining that the output is associated with outside information:
determining at least one data source to retrieving additional information;
retrieving the additional information from the data source;
wherein the sending the output to the user comprising augmenting the output with the additional information for output to the user.

6. The method of claim 4, wherein the at least one data source comprises at least a trusted data source with each information entry associated with a checksum.

7. The method of claim 2, wherein the query comprises a natural language expression.

8. The method of claim 2, wherein retrieving a set of values comprises retrieving from at least one trusted data source with each information entry associated with a checksum; and wherein storing the at least one of the hash value, the checksum, or the vector with the output as the value of the query comprises storing to the least one trusted data source.

9. A method implemented on AI-enabled device, the method comprising:
receiving a query of a user of the AI-enabled device;
sending the query to a server;
receiving a response from the server;
sending the output to the user.

10. The method of claim 9, wherein the output comprises additional information from a trusted data source.

11. A method implemented on AI-enabled server device, the method comprising:
receiving a query of a user of the AI-enabled device;
generating an output of the query using a knowledge base or a large-language-model (LLM);
generating a cryptographic value based on the output of the query; and
sending the cryptographic value to the user.

12. The method of claim 11, where generating an output comprises:
sending the output of the query to an intermediate validation agent;
generating, at the intermediate validation agent, the cryptographic value, and wherein sending the cryptographic value to user comprises sending from the intermediate validation agent.

13. The method of claim 11, wherein generating a cryptographic value comprises at least one of:
a) generating an encrypted value based a combination of the value and a cryptographic key; or
b) generating a response comprising the value and a checksum based on the value with an initialization data.

14. The method of claim 13, further comprising storing at least one of the output of the query, the encrypted value or the response in a secure database as a stored value;
wherein the stored value is provided as a value in lieu of generating a new output of the query when the stored value is threshold distance from a notional new output.

15. The method of claim 11, further comprising:
sending at least one cryptographic key as at least one pre-shared key to the user, wherein generating a cryptographic value is based on the least one pre-shared key.
